(19) United States
(12) Patent Application Publication
(10) Pub. No.: US 2024/0257440 A1
(43) Pub. Date: Aug. 1, 2024

(54) INFORMATION PROCESSING APPARATUS, INFORMATION PROCESSING METHOD, AND PROGRAM

(71) Applicant: Sony Group Corporation, Tokyo (JP)

(72) Inventor: Keisuke NAKAMURA, Kanagawa (JP)

(73) Assignee: Sony Group Corporation, Tokyo (JP)

(21) Appl. No.: 18/293,780

(22) PCT Filed: Feb. 17, 2022
(86) PCT No.: PCT/JP2022/006403

§ 371 Date: Jan. 31, 2024

(30) Foreign Application Priority Data
Aug. 10, 2021 (JP) 2021-130706

(51) Int. Cl. G06T 15/08

(52) U.S. Cl. CPC G06T 15/08

(57) ABSTRACT

It is desirable to provide a technique capable of performing rendering based on polygon data and volume data while reducing discomfort given to a user. There is provided an information processing apparatus including a search unit that searches volume data on the basis of a label indicating whether to search the volume data for inner-side data present at a position included in polygon data, and that obtains a search result; and a rendering unit that performs rendering based on the polygon data and the volume data on the basis of the search result.

### TECHNICAL FIELD

The present disclosure relates to an information processing apparatus, an information processing method, and a program.

### BACKGROUND ART

In recent years, a technique related to synthesis of rendering results of polygon data and volume data is known. In such a technique, in a case where the rendering result of the polygon data is unconditionally overwritten and displayed by the rendering result of the volume data, the number of cases where the polygon data is not displayed increases. Therefore, a technique for limiting a search distance of volume data is disclosed (for example, refer to Patent Document 1).

### CITATION LIST

### Patent Document

Patent Document 1: Japanese Patent No. 6223916

### SUMMARY OF THE INVENTION

### Problems to be Solved by the Invention

However, it is desirable to provide a technique capable of performing rendering based on polygon data and volume data while reducing discomfort given to a user.

### Solutions to Problems

According to one aspect of the present disclosure, there is provided an information processing apparatus including a search unit that searches volume data on the basis of a label indicating whether to search the volume data for inner-side data present at a position included in polygon data, and that obtains a search result; and a rendering unit that performs rendering based on the polygon data and the volume data on the basis of the search result.

Furthermore, according to another aspect of the present disclosure, there is provided an information processing method including searching volume data on the basis of a label indicating whether to search the volume data for inner-side data present at a position included in polygon data, and obtaining a search result; and performing rendering based on the polygon data and the volume data on the basis of the search result via a processor.

Furthermore, according to still another aspect of the present disclosure, there is provided a program causing a computer to function as an information processing apparatus including a search unit that searches volume data on the basis of a label indicating whether to search the volume data for inner-side data present at a position included in polygon data, and that obtains a search result; and a rendering unit that performs rendering based on the polygon data and the volume data on the basis of the search result.

### BRIEF DESCRIPTION OF DRAWINGS

FIG. 1 is a diagram for describing an outline of a ray tracing method.

FIG. 2 is a diagram illustrating a state of rays splashed to polygon data in an existing technique.

FIG. 3 is a diagram illustrating a state in which rays reach volume data in the existing technique.

FIG. 4 is a diagram illustrating data that a ray reaches in volume data and polygon data in a distinguishable manner, in the existing technique.

FIG. 5 is a diagram illustrating inner-side data, near-side data, and polygon data from a viewpoint side.

FIG. 6 is a diagram illustrating an example of polygon data.

FIG. 7 is a diagram illustrating an example of volume data.

FIG. 8 is a diagram for describing an example of rendering aimed to be realized in an embodiment of the present disclosure.

FIG. 9 is a diagram illustrating an example of a rendering target aimed to be realized in an embodiment of the present disclosure.

FIG. 10 is a diagram for describing a case where rendering aimed to be realized in an embodiment of the present disclosure is attempted to be realized using the existing technique.

FIG. 11 is a diagram for describing a configuration example of an information processing apparatus according to an embodiment of the present disclosure.

FIG. 12 is a diagram illustrating a configuration example of polygon data according to an embodiment of the present disclosure.

FIG. 13 is a diagram for describing an example of searching for inner-side data using a label.

FIG. 14 is a diagram for describing an example of rendering according to an embodiment of the present disclosure.

FIG. 15 is a flowchart illustrating an operation example of a polygon data rendering unit.

FIG. 16 is a flowchart illustrating an operation example of a volume data rendering unit.

FIG. 17 is a flowchart illustrating an operation example of a volume data rendering unit.

FIG. 18 is a diagram for describing an outline of a ray marching method.

FIG. 19 is a flowchart illustrating an operation example of an information processing apparatus according to a first modification example.

FIG. 20 is a diagram for describing a configuration example of an information processing apparatus according to a second modification example.

FIG. 21 is a block diagram illustrating a hardware configuration example of an information processing apparatus.

### MODE FOR CARRYING OUT THE INVENTION

Hereinafter, preferred embodiments of the present disclosure will be described in detail with reference to the accompanying drawings. Note that, in the present specification and the drawings, components having substantially the same functional configurations are denoted by the same reference signs, and redundant descriptions are omitted.

Furthermore, in the present specification and the drawings, a plurality of components having substantially the same or similar functional configurations may be distinguished by attaching different numbers after the same reference signs. However, in a case where it is not particularly necessary to distinguish each of a plurality of components having substantially the same or similar functional configurations, only the same reference signs are attached. Furthermore, similar components of different embodiments may be distinguished by adding different alphabets after the same reference signs. However, in a case where it is not necessary to particularly distinguish each of similar components, only the same reference signs are assigned.

Note that the description will be given in the following order.
0. Outline
1. Details of Embodiment
1.1. Configuration Example
1.2. Functional Details
1.3. Operation Example
2. Various Modification Examples
3. Hardware Configuration Example
4. Summary

### 0. Outline

First, an outline of an embodiment of the present disclosure will be described.

In recent years, computer graphics (CG) has been used in various fields. The CG can be a technique for generating an image using a computer. Rendering can be performed in a process of generating an image by the CG.

Here, rendering may mean generating an image by processing various kinds of data using a computer. In particular, rendering in CG may be a technique that converts modeled three-dimensional data into two-dimensional images. Modeling may mean defining the shape, color, and the like of an object as the three-dimensional data.

Examples of the object include polygon data and volume data. In the embodiment of the present disclosure, a case where rendering based on polygon data and volume data is performed is assumed.

Here, the polygon data is configured by a combination of a plurality of polygons. Note that the polygon may mean a multiple-sided shape. In general, polygon data is configured by a combination of triangles (multiple-sided shape having three vertices), but may be configured by multiple-sided shapes (multiple-sided shape having four or more vertices) other than triangles. The polygon data has a feature of suppressing a data size, a feature of easily expressing texture of a surface, and the like. Therefore, the polygon data is suitable for expressing a face, a skin, an opaque dress, and the like.

On the other hand, the volume data is configured by a combination of a plurality of voxels. The voxel is a minimum unit constituting the volume data, and is typically configured by a cube (normal lattice). The volume data has a feature that the degree of reproduction of a complicated shape is high, a feature that transparent expression is easily performed, and the like. Therefore, the volume data is suitable for expressing hair, translucent dress, and the like.

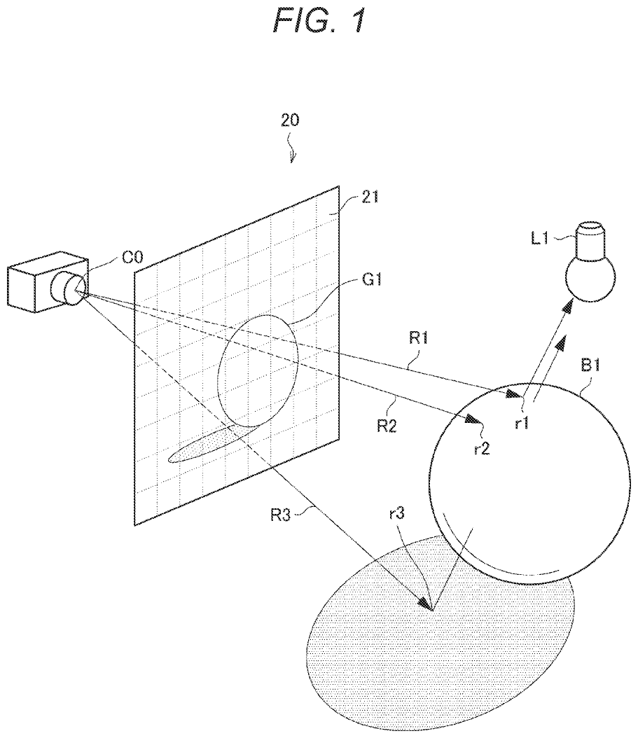

In the embodiment of the present disclosure, a case where a ray tracing method is used as an example of rendering volume data is assumed. First, an outline of a ray tracing method applied to volume data according to the embodiment of the present disclosure will be described with reference to FIG. 1.

FIG. 1 is a diagram for describing an outline of the ray tracing method. Referring to FIG. 1, there is an object B1 modeled in a CG space. In the embodiment of the present disclosure, the object B1 may be volume data. Furthermore, a viewpoint C0 is present in the CG space. The position of the viewpoint C0 can be appropriately changed according to an operation by the user.

Furthermore, a virtual screen 20 is present between the viewpoint C0 and the object B1. The screen 20 includes a plurality of pixels. Here, each of the plurality of pixels is a minimum unit of color information. That is, a set of color information of each of the plurality of pixels on the screen 20 can correspond to an image generated by the CG. In FIG. 1, a pixel 21 is illustrated representing a plurality of pixels.

In the ray tracing method, a line of sight (hereinafter, it is also referred to as a “ray”) is sequentially splashed from the viewpoint C0 to each pixel of the screen 20. Then, a point at which each ray first intersects the object is calculated. In FIG. 1, rays R1 to R3 are illustrated as examples of rays that are splashed to each pixel. Furthermore, points r1 to r3 where the rays R1 to R3 first intersect the object are illustrated.

Then, brightness of each point is calculated on the basis of color information at each point, brightness of a light source L1, a positional relationship between the light source L1 and each point, and the like. The brightness of each point calculated in this manner is treated as color information of the pixel corresponding to each point. Note that, in calculating the brightness of each point, not only light that directly reaches each point from the light source L1 but also light that is emitted from the light source L1, reflected by some object, and reaches each point may be considered. In this manner, the color information of each pixel of the screen 20 is calculated, and an image is generated.

The outline of the ray tracing method has been described above.

In the above description, a case where volume data is displayed as an example of the object B1 has been mainly assumed. Subsequently, a case of not only performing rendering of the volume data but also combining a rendering result of polygon data and a rendering result of volume data is assumed. In this case, in a case where the rendering result of the polygon data is unconditionally overwritten and displayed by the rendering result of the volume data, the number of cases where the polygon data is not displayed increases.

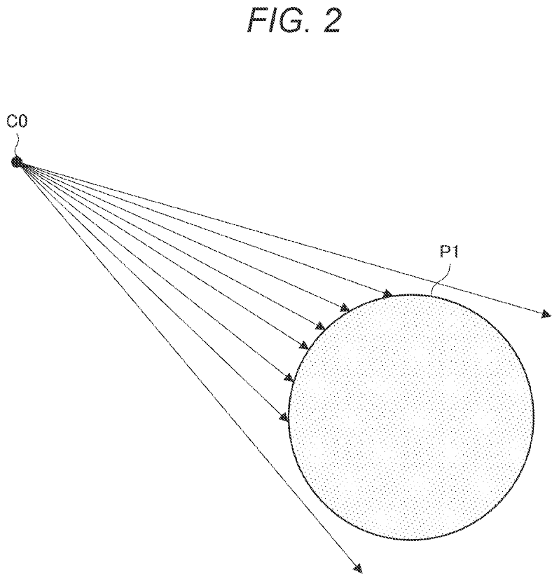

Therefore, an existing technique for limiting a search distance of volume data is disclosed. Such an existing technique will be briefly described with reference to FIGS. 2 to 4.

FIG. 2 is a diagram illustrating a state of rays splashed to polygon data in the existing technique. Referring to FIG. 2, the viewpoint C0 and polygon data P1 are illustrated. Furthermore, the ray splashed from the viewpoint C0 is indicated by each arrow. As illustrated in FIG. 2, in the existing technique, a length of each ray is limited to a distance from the viewpoint C0 to a surface of the polygon data P1 (depth of the polygon data P1).

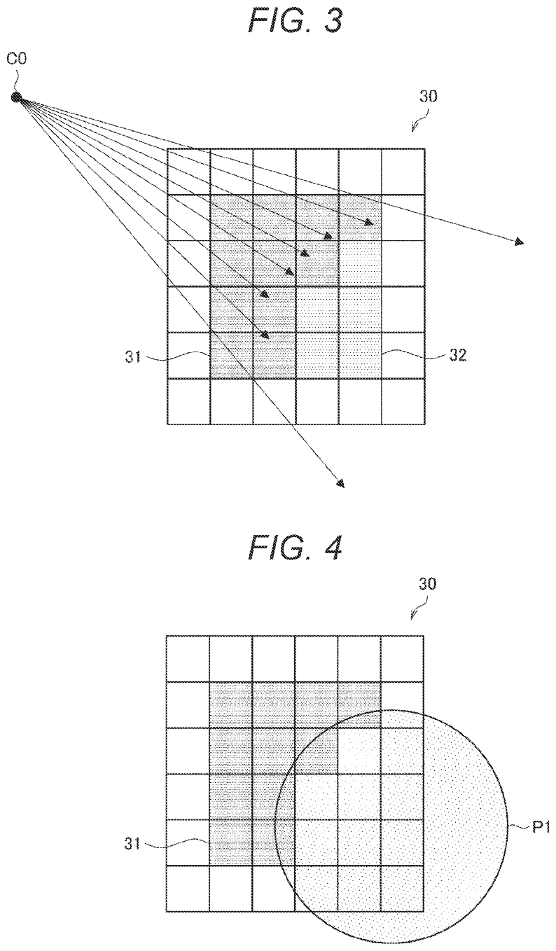

FIG. 3 is a diagram illustrating a state in which rays reach volume data in the existing technique. Referring to FIG. 3, in volume data 30, data that the ray reaches is illustrated as near-side data 31, and data 32 that the ray does not reach is illustrated as inner-side data 32. In the existing technique, the near-side data 31 is a rendering target, but the inner-side data 32 is not a rendering target.

FIG. 4 is a diagram illustrating data that the ray reaches in the volume data and the polygon data in a distinguishable manner, in the existing technique. Referring to FIG. 4, in the existing technique, the data that the ray reaches in the volume data 30 is limited to the near-side data 31 located in front of the polygon data P1 with the viewpoint C0 as a reference. On the other hand, the inner-side data 32 is not reached by the ray.

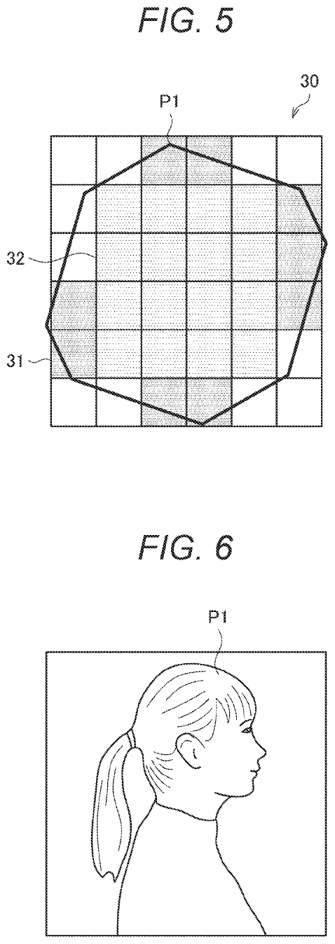

The existing technique has been briefly described above. In the existing technique, the inner-side data 32 is not reached by a ray. Therefore, the inner-side data 32 is not a rendering target. However, it may be desired to set the inner-side data 32 as a rendering target. An example of a case where it is desired to set the inner-side data 32 as a rendering target will be described with reference to FIGS. 5 to 10.

FIG. 5 is a diagram illustrating the inner-side data, the near-side data, and the polygon data from the viewpoint side. Referring to FIG. 5, the polygon data P1 is illustrated. In the volume data 30, the data present on the surface of the polygon data P1 corresponds to the near-side data 31. On the other hand, in the volume data 30, the data present at the position included in the polygon data P1 corresponds to the inner-side data 32. It may be desired to set this inner-side data 32 as a rendering target.

FIG. 6 is a diagram illustrating an example of the polygon data. Referring to FIG. 6, the polygon data P1 is illustrated. The polygon data P1 includes polygon data of each part of a face, hair, and an opaque dress of a person. Here, as described above, the polygon data P1 is suitable for expressing the face and the opaque dress. However, the polygon data P1 is not very suitable for expressing the hair.

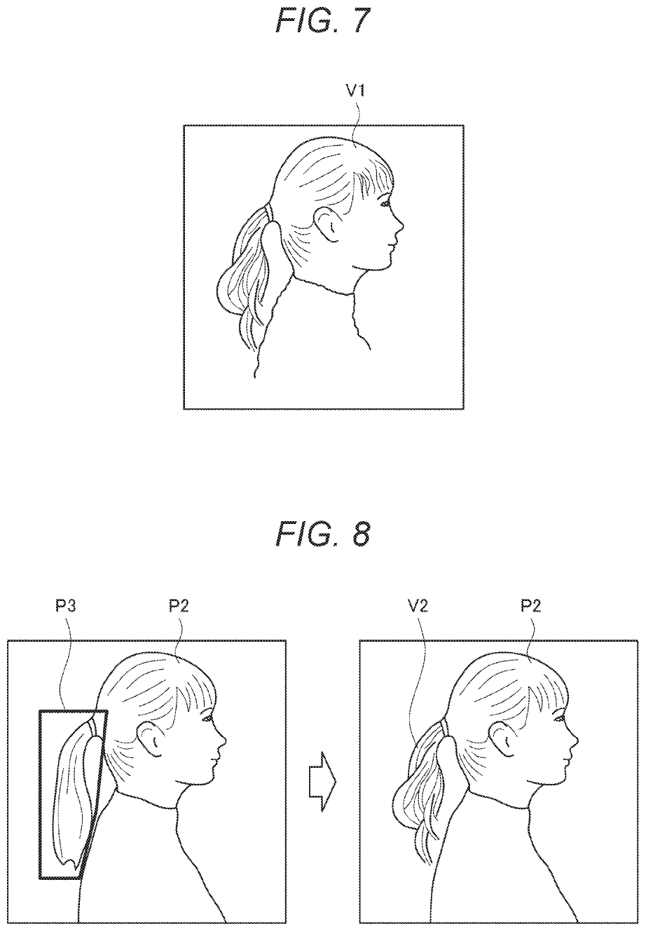

FIG. 7 is a diagram illustrating an example of the volume data. Referring to FIG. 7, volume data V1 is illustrated. Similarly to the polygon data P1, the volume data V1 includes volume data of each part of the face, the hair, and the opaque dress of the person. Here, as described above, the volume data V1 is suitable for expressing the hair. However, the volume data V1 is not very suitable for expressing the face and the opaque dress.

FIG. 8 is a diagram for describing an example of rendering aimed to be realized in the embodiment of the present disclosure. Referring to FIG. 8 (left side of the arrow), in the polygon data P1 (FIG. 6), polygon data P3 of the hair part and polygon data P2 other than the hair part are illustrated. As described above, volume data is more suitable than polygon data for expressing the hair. Conversely, polygon data is more suitable than volume data for expressing the face and the opaque dress.

Therefore, in the embodiment of the present disclosure, as illustrated in FIG. 8 (right side of the arrow), the polygon data P3 of the hair part is not the rendering target. Instead, in the embodiment of the present disclosure, as illustrated in FIG. 8 (right side of the arrow), it is aimed to set volume data V2 of the hair part present at the position included in the polygon data P3 of the hair part, as the rendering target. Note that the volume data V2 of the hair part is merely an example of the inner-side data. Therefore, the inner-side data is not limited to the volume data of the hair part.

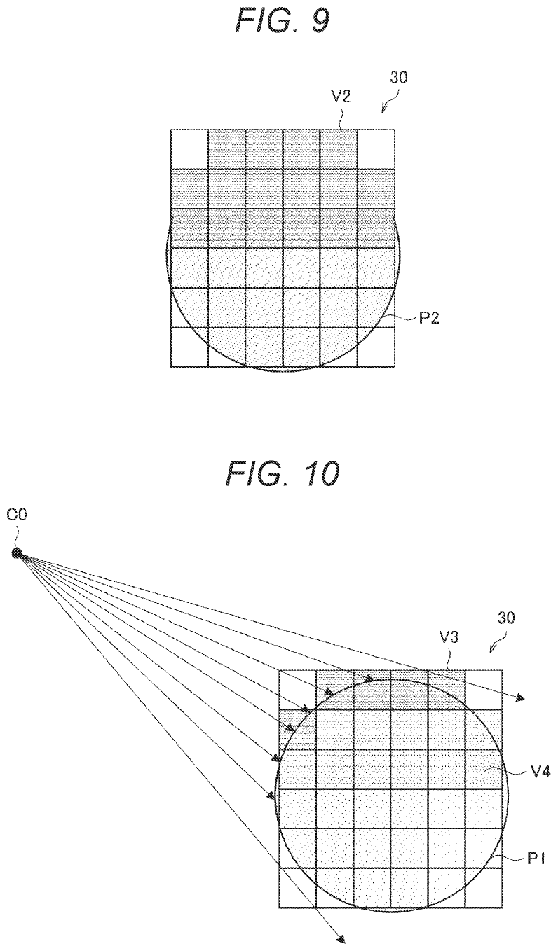

FIG. 9 is a diagram illustrating an example of the rendering target aimed to be realized in the embodiment of the present disclosure. Referring to FIG. 9, the polygon data P2 other than the hair part is illustrated. Furthermore, the volume data V2 of the hair part present at the position included in the polygon data P3 (FIG. 8) of the hair part is illustrated. As illustrated in FIG. 9, in the embodiment of the present disclosure, as an example, it is aimed to set the polygon data P2 other than the hair part and the volume data V2 of the hair part as the rendering targets.

FIG. 10 is a diagram for describing a case where rendering aimed to be realized in the embodiment of the present disclosure is attempted to be realized using the existing technique. As illustrated in FIG. 10, in the existing technique, the length of each ray is limited to the distance from the viewpoint C0 to the surface of the polygon data P1.

Therefore, in the existing technique, in the volume data 30, near-side data V3 is the rendering target, but inner-side data V4 is not the rendering target. Therefore, in the existing technique, only a part of the volume data V2 (FIG. 9) of the hair part present at the position included in the polygon data P1 becomes the rendering target.

Therefore, in the embodiment of the present disclosure, as an example, it is aimed to set the volume data present at the position included in the polygon data as the rendering target. As a result, rendering utilizing the respective features of the polygon data and the volume data is performed, and thus rendering with reduced discomfort given to the user is expected to be possible.

The outline of the embodiment of the present disclosure has been described above.

### 1. Details of Embodiment

Next, the embodiment of the present disclosure will be described in detail.

### 1.1. Configuration Example

First, a configuration example of the information processing apparatus according to the embodiment of the present disclosure will be described.

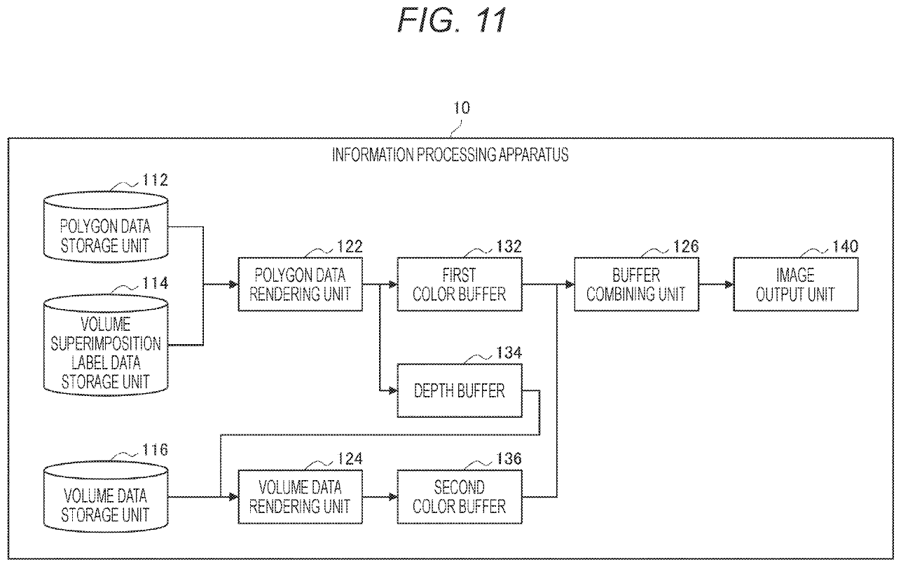

FIG. 11 is a diagram for describing a configuration example of the information processing apparatus according to the embodiment of the present disclosure. An information processing apparatus 10 according to the embodiment of the present disclosure is realized by a computer, and includes a control unit (not illustrated) and a storage unit (not illustrated).

### (Control Unit)

The control unit (not illustrated) may include one or a plurality of central processing units (CPUs), for example. In a case where the control unit (not illustrated) includes a processor such as a CPU, the processor may include an electronic circuit. The control unit (not illustrated) can be realized by a program executed by such a processor.

The control unit (not illustrated) includes a polygon data rendering unit 122, a volume data rendering unit 124, a buffer combining unit 126, and an image output unit 140. Details of these blocks will be described later.

### (Storage Unit)

The storage unit (not illustrated) is a recording medium that has a configuration including a memory and, for example, stores a program to be executed by the control unit (not illustrated) and data necessary for executing this program. Furthermore, the storage unit (not illustrated) temporarily stores data for calculation performed by the control unit (not illustrated). The storage unit (not illustrated) includes a magnetic storage unit device, a semiconductor storage device, an optical storage device, a magneto-optical storage device, or the like.

The storage unit (not illustrated) includes a polygon data storage unit 112, a volume superimposition label data storage unit 114, a volume data storage unit 116, a first color buffer 132, a depth buffer 134, and a second color buffer 136. Details of these blocks will be described later.

In the technique according to the embodiment of the present disclosure, a label indicating whether to search the volume data for the inner-side data is associated in advance for each region of the polygon data. Then, the information processing apparatus 10 according to the embodiment of the present disclosure includes a search unit (not illustrated) that searches the volume data on the basis of the label to obtain a search result, and a rendering unit (not illustrated) that performs rendering based on the polygon data and the volume data on the basis of the search result.

As a result, the volume data present at the position included in the polygon data can be set as the rendering target. Then, as a result, rendering utilizing the respective features of the polygon data and the volume data is performed, so that rendering with reduced discomfort given to the user is expected to be possible.

Note that the search unit (not illustrated) can be realized by the polygon data rendering unit 122 and the volume data rendering unit 124. Furthermore, the rendering unit (not illustrated) can be realized by the volume data rendering unit 124 and the buffer combining unit 126.

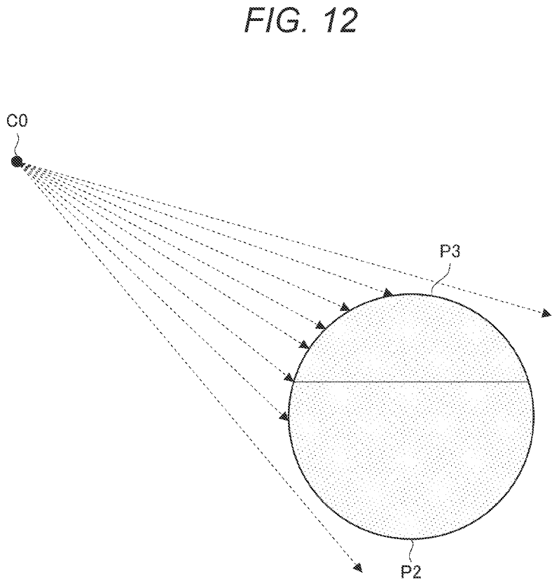

FIG. 12 is a diagram illustrating a configuration example of the polygon data according to the embodiment of the present disclosure. As illustrated in FIG. 12, in the embodiment of the present disclosure, the polygon data includes the polygon data P3 of the hair part and the polygon data P2 other than the hair part. As described above, in the embodiment of the present disclosure, in the volume data, the inner-side data present at the position included in the polygon data P2 other than the hair part is not the rendering target, and the inner-side data present at the position included in the polygon data P3 of the hair part is the rendering target.

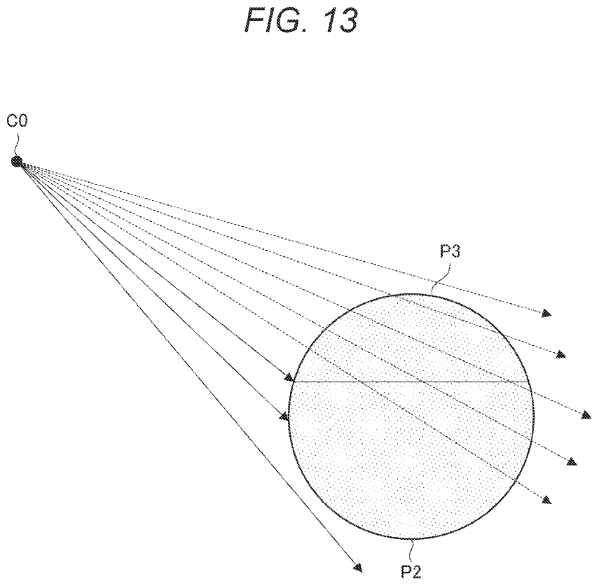

FIG. 13 is a diagram for describing an example of searching for the inner-side data using the label. In the embodiment of the present disclosure, a label indicating that the inner-side data is to be searched for is associated with the polygon data P3 of the hair part. On the other hand, a label indicating that the inner-side data is not to be searched for is associated with the polygon data P2 other than the hair part.

As a result, the distance (ray tracing distance) of the ray splashed toward the polygon data P3 of the hair part is extended to reach the inner-side data of the polygon data P3 of the hair part. Therefore, the search unit (not illustrated) searches for the inner-side data of the polygon data P3 of the hair part associated with the label on the basis of the label indicating that the inner-side data is to be searched for.

On the other hand, the distance of the ray splashed toward the polygon data P2 other than the hair part is limited to the surface of the polygon data P2 other than the hair part. Therefore, the search unit (not illustrated) does not search for the inner-side data of the polygon data P2 other than the hair part associated with the label on the basis of the label indicating that the inner-side data is not to be searched for.

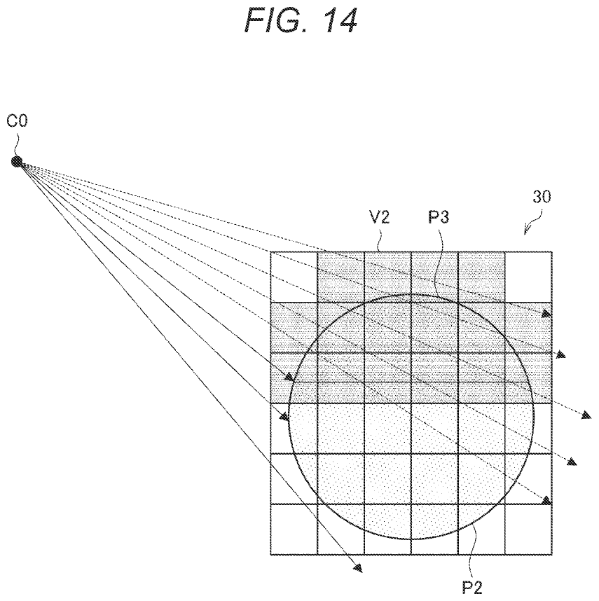

FIG. 14 is a diagram for describing an example of rendering according to the embodiment of the present disclosure. As illustrated in FIG. 14, in the technique according to the embodiment of the present disclosure, the distance of the ray splashed toward the polygon data P2 other than the hair part is limited to the surface of the polygon data P2 other than the hair part. Therefore, in the volume data, the inner-side data of the polygon data P2 other than the hair part is not the rendering target.

On the other hand, the distance of the ray splashed toward the polygon data P3 of the hair part is extended to reach the inner-side data of the polygon data P3 of the hair part. Therefore, the volume data V2 of the hair part present at the position included in the polygon data P3 of the hair part is the rendering target.

Note that the search unit (not illustrated) searches the volume data in a depth direction with the viewpoint C0 as a reference. In this case, regardless of the label, in the volume data, the near-side data located in front of the polygon data is searched for with the viewpoint C0 as a reference. That is, in the volume data, the near-side data located in front of the polygon data is the rendering target, regardless of the label.

The configuration example of the information processing apparatus 10 according to the embodiment of the present disclosure has been described above.

### 1.2. Functional Details

Next, functional details of the information processing apparatus 10 according to the embodiment of the present disclosure will be described.

### (Polygon Data Storage Unit 112)

The polygon data storage unit 112 stores polygon data. As described above, the polygon data is configured by a combination of a plurality of polygons. More specifically, the polygon data includes data regarding vertices respectively constituting the plurality of polygons. For example, data regarding a vertex includes a name of the vertex and coordinates of the vertex.

Here, the name of the vertex is information for uniquely identifying the vertex in a relevant frame. The coordinates of the vertex are coordinates expressing the position of the vertex. As an example, the coordinates of the vertex can be expressed by three-dimensional coordinates (x coordinate, y coordinate, z coordinate).

Furthermore, the vertices constituting the polygon correspond to coordinates (UV coordinates) in the texture to be pasted to the polygon data. The texture includes color information and transmittance. Hereinafter, an RGB value will be described as an example of the color information, but the color information may be expressed by any method. Furthermore, the transmittance may be an a value.

Note that, in the following, a case where the polygon data is three-dimensional data extracted from an object appearing in data (imaging data) imaged at a certain time point will be mainly described. In this case, the three-dimensional data can be configured by one frame at a certain time point. However, the polygon data may be configured by a plurality of frames.

For example, a volumetric capture technique has been known as an example of a technique for extracting the three-dimensional data of the object appearing in the imaging data on the basis of the data (imaging data) continuously imaged in time series by a plurality of cameras. Such a volumetric capture technique reproduces a three-dimensional moving image of the object from any viewpoint using the extracted three-dimensional data.

The three-dimensional data extracted by the volumetric capture technique is also referred to as volumetric data. The volumetric data is three-dimensional moving image data configured by frames at each of a plurality of consecutive times. The polygon data may be a plurality of frames obtained in this manner.

### (Volume Superimposition Label Data Storage Unit 114)

The volume superimposition label data storage unit 114 stores a label indicating whether to search the volume data for the inner-side data, which is present at the position included in the polygon data. Such a label is associated with each region of the polygon data in advance. A method of labeling each region of the polygon data is not limited. For example, a texture corresponding to the polygon data may be labeled.

For example, the texture may be labeled manually. Alternatively, the texture may be labeled using part detection by machine learning. For example, in a case where a label indicating that the inner-side data is to be searched for is associated with the hair part, the hair part may be detected by machine learning, and the label indicating that the inner-side data is to be searched for may be associated with the detected hair part.

### (Volume Data Storage Unit 116)

The volume data storage unit 116 stores the volume data. The volume data is configured by a plurality of voxels. The RGB value and the a value are assigned to each voxel. In the following, a case where the volume data is three-dimensional data extracted from an object appearing in data (imaging data) imaged at a certain time point will be mainly described. However, similarly to the polygon data, the volume data may be configured by a plurality of frames.

### (Polygon Data Rendering Unit 122)

The polygon data rendering unit 122 acquires the polygon data from the polygon data storage unit 112. Moreover, the polygon data rendering unit 122 acquires the label from the volume superimposition label data storage unit 114. Then, the polygon data rendering unit 122 renders the polygon data on the basis of the acquired label and polygon data. More specifically, the polygon data rendering unit 122 executes a vertex shader.

By execution of the vertex shader, the positions (that is, in which pixel of the two-dimensional image the vertex is located) of the plurality of vertices constituting the polygon data in a screen coordinate system are calculated. Moreover, coordinates in the texture corresponding to each of the plurality of vertices constituting the polygon data are calculated as texture coordinates by the vertex shader.

The polygon data rendering unit 122 executes a pixel shader. In the pixel shader, processing of the pixel is sequentially executed. In this case, the polygon data rendering unit 122 executes processing of the pixel being processed on the basis of the label associated with the pixel being processed.

More specifically, the polygon data rendering unit 122 writes a distance corresponding to the label associated with the pixel being processed, into the depth buffer 134 as the ray tracing distance.

For example, in a case where the label indicates that the inner-side data is to be searched for, the polygon data rendering unit 122 writes a predetermined distance at a position corresponding to the pixel being processed in the depth buffer 134 on the basis of the label indicating that the inner-side data is to be searched for. Here, the predetermined distance may be a distance equal to or greater than a maximum value of the distance between the viewpoint C0 and the volume data. This may ensure sufficient ray tracing distance for the inner-side data to be searched for in the pixel being processed.

Moreover, in a case where the label indicates that the inner-side data is to be searched for, the polygon data is not the rendering target. Therefore, the polygon data rendering unit 122 writes α value=0 at the position corresponding to the pixel being processed in the first color buffer 132, on the basis of the label indicating that the inner-side data is to be searched for. Note that the RGB values may not be written at the position corresponding to the pixel being processed in the first color buffer 132.

On the other hand, in a case where the label indicates that the inner-side data is not to be searched for, the polygon data rendering unit 122 writes the depth of the polygon data in the pixel being processed into the position corresponding to the pixel being processed in the depth buffer 134, on the basis of the label indicating that the inner-side data is not to be searched for. The depth of the polygon data in the pixel being processed may correspond to the distance between the viewpoint C0 and the polygon data in the pixel being processed. This prevents the inner-side data from being searched for in the pixel being processed.

Moreover, in a case where the label indicates that the inner-side data is not to be searched for, the polygon data is the rendering target. Therefore, the polygon data rendering unit 122 determines the color information (RGB value) and the a value of the pixel being processed on the basis of the texture coordinates and the texture of the pixel being processed on the basis of the label indicating that the inner-side data is not to be searched for, and writes the determined color information (RGB value) and the determined a value at the position corresponding to the pixel being processed in the first color buffer 132.

### (Volume Data Rendering Unit 124)

The volume data rendering unit 124 acquires the volume data from the volume data storage unit 116. Moreover, the volume data rendering unit 124 reads the ray tracing distance from the depth buffer 134. The volume data rendering unit 124 sequentially selects pixels, and performs rendering of the volume data corresponding to the selected pixel on the basis of the ray tracing distance corresponding to the selected pixel.

The volume data rendering unit 124 causes the ray (point of interest) to advance stepwise in the depth direction with the viewpoint C0 as a reference, and extracts the volume data present at the position of the ray in a case where the length of the ray (that is, the distance between the viewpoint C0 and the point of interest) is smaller than the ray tracing distance written in the depth buffer 134 and the volume data is present at the position of the ray.

The volume data rendering unit 124 combines the volume data extracted in the pixel being selected, on the basis of the a value of the volume data extracted in the pixel being selected, to acquire a volume data combining result.

More specifically, the volume data rendering unit 124 may combine the R values of the volume data extracted in the pixel being selected, by a blending. Similarly, the volume data rendering unit 124 may combine the G values of the volume data extracted in the pixel being selected, by α blending. Furthermore, the volume data rendering unit 124 may combine the B values of the volume data extracted in the pixel being selected, by α blending.

In a case where the total value of the a values of the volume data extracted in the pixel being selected is smaller than a predetermined value, the volume data rendering unit 124 maintains the pixel being selected and causes the ray to advance. For example, the predetermined value may be one. In such a case, the volume data rendering unit 124 similarly extracts the volume data present at the position of the ray.

A case is assumed in which the total value of the a values of the volume data extracted in the pixel being selected is equal to or greater than a predetermined value. In such a case, the volume data rendering unit 124 writes the volume data combining result, which is a combining result of the volume data extracted in the pixel being selected, to the position corresponding to the pixel being selected, in the second color buffer 136.

Then, the volume data rendering unit 124 selects the next pixel, and performs similar processing on the selected pixel. In a case where there is no unprocessed pixel, the operation is shifted from the volume data rendering unit 124 to the buffer combining unit 126.

### (Buffer Combining Unit 126)

The buffer combining unit 126 acquires the RGBα value of each pixel in the two-dimensional image corresponding to the polygon data from the first color buffer 132 as the rendering result of the polygon data. Moreover, the buffer combining unit 126 acquires the RGBα value of each pixel in the two-dimensional image corresponding to the volume data from the second color buffer 136 as the rendering result of the volume data.

The buffer combining unit 126 combines the rendering result of the polygon data and the rendering result of the volume data. More specifically, the rendering result of the polygon data and the rendering result of the volume data are combined by a blending. The buffer combining unit 126 outputs a combining result to the image output unit 140.

### (Image Output Unit 140)

The image output unit 140 acquires the combining result input from the buffer combining unit 126. Then, the image output unit 140 outputs the acquired combining result. The combining result by the image output unit 140 may be transmitted to another device or may be displayed on a display. The combining result displayed on the display may be visually recognized by the user.

Note that, the type of the display is not especially limited. For example, the display may be a liquid crystal display (LCD), an organic electro-luminescence (EL) display, a plasma display panel (PDP), or the like.

For example, the output result of the pixel corresponding to the label indicating that the inner-side data is to be searched for is the combining result of the volume data. On the other hand, the output result of the pixel corresponding to the label indicating that the inner-side data is not to be searched for is the combining result of the rendering result of the polygon data and the combining result of the volume data.

However, in any case, in a case where the near-side data is not extracted, the combining result of the volume data may be the rendering result of the inner-side data. On the other hand, in a case where the near-side data is extracted, the combining result of the volume data is the combining result of the near-side data and the inner-side data.

The functional details of the information processing apparatus 10 according to the embodiment of the present disclosure has been described above.

### 1.3. Operation Example

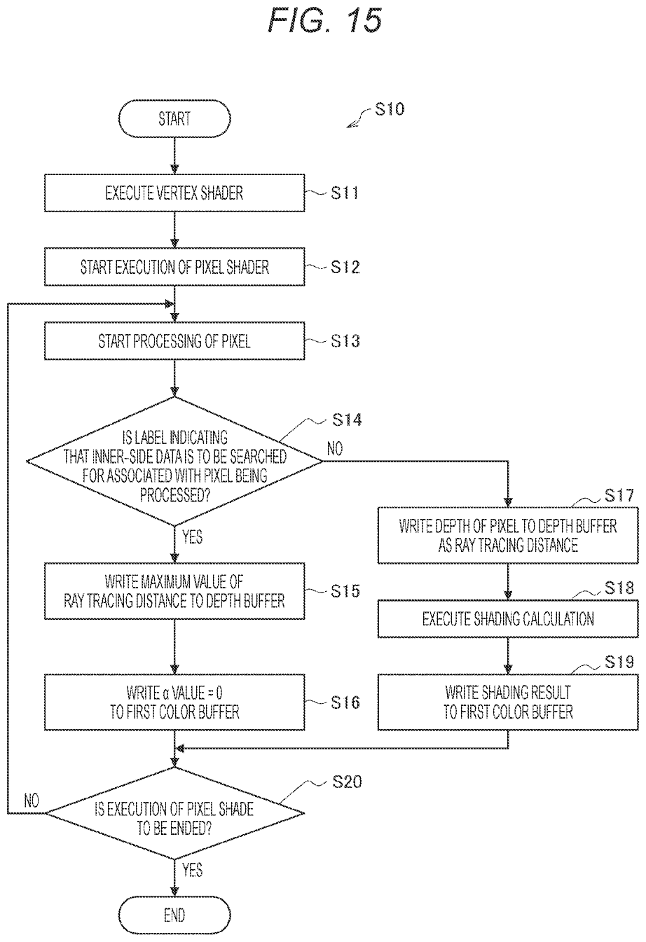

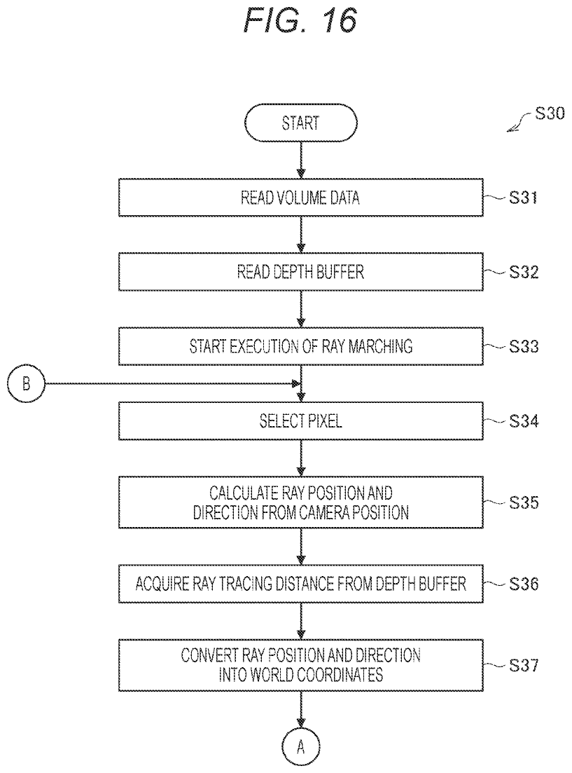

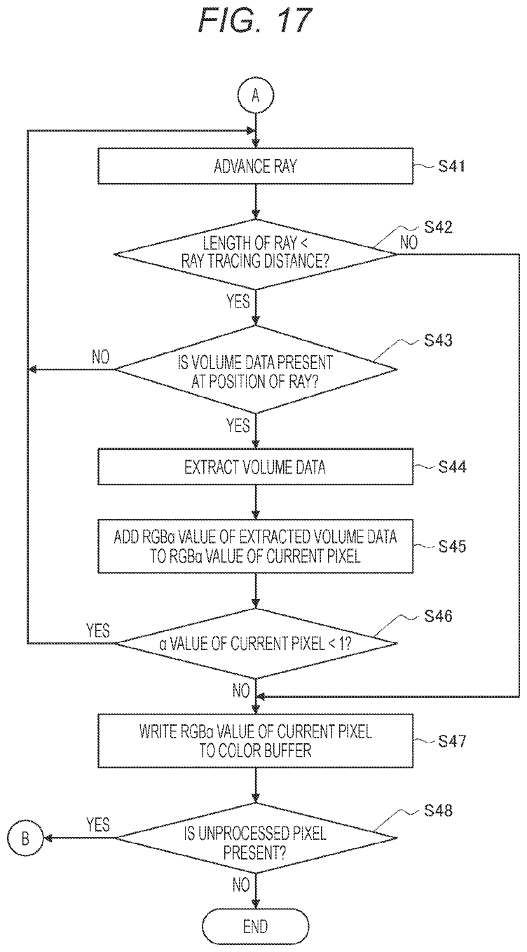

Subsequently, an operation example of the information processing apparatus 10 according to the embodiment of the present disclosure will be described in detail. First, an operation example of the polygon data rendering unit 122 will be described with reference to FIG. 15, and subsequently, an operation example of the volume data rendering unit 124 will be described with reference to FIGS. 16 and 17.

### (Operation of Polygon Data Rendering Unit 122)

FIG. 15 is a flowchart illustrating an operation example of the polygon data rendering unit 122. The polygon data rendering unit 122 acquires the polygon data from the polygon data storage unit 112. Moreover, the polygon data rendering unit 122 acquires the label from the volume superimposition label data storage unit 114. As illustrated in FIG. 15, the polygon data rendering unit 122 executes the vertex shader (S11).

By execution of the vertex shader, the position of each of the plurality of vertices constituting the polygon data in the screen coordinate system is calculated. Moreover, coordinates in the texture corresponding to each of the plurality of vertices constituting the polygon data are calculated as texture coordinates by the vertex shader.

Subsequently, the polygon data rendering unit 122 starts execution of the pixel shader (S12). In the pixel shader, the polygon data rendering unit 122 starts processing of the pixel (S13).

In a case where a label indicating that the inner-side data is to be searched for is associated with the pixel being processed (“NO” in S14), the polygon data rendering unit 122 writes the maximum value of the ray tracing distance to the position corresponding to the pixel being processed in the depth buffer 134 (S15). Then, the polygon data rendering unit 122 writes a value=0 at the position corresponding to the pixel being processed in the first color buffer 132 (S16). Subsequently, the polygon data rendering unit 122 shifts the operation to S20.

On the other hand, in a case where a label indicating that the inner-side data is not to be searched for is associated with the pixel being processed (“NO” in S14), the polygon data rendering unit 122 writes the depth of the polygon data in the pixel being processed as the ray tracing distance, at the position corresponding to the pixel being processed in the depth buffer 134 (S17).

Moreover, the polygon data rendering unit 122 executes shading calculation (S18). In the shading calculation, the color information (RGB values) and the x value of the pixel being processed are determined on the basis of the texture coordinates and texture of the pixel being processed. The polygon data rendering unit 122 writes the determined color information (RGB value) and a value as a shading result at the position corresponding to the pixel being processed in the first color buffer 132 (S19). Subsequently, the polygon data rendering unit 122 shifts the operation to S20.

While the execution of the pixel shader is not to be ended (“NO” in S20), the polygon data rendering unit 122 shifts the operation to S13. On the other hand, in a case where the execution of the pixel shader is to be ended (“YES” in S20), the polygon data rendering unit 122 ends the rendering of the polygon data (S10).

### (Operation of Volume Data Rendering Unit 124)

FIGS. 16 and 17 are flowcharts illustrating an operation example of the volume data rendering unit 124. As illustrated in FIG. 16, the volume data is acquired from the volume data storage unit 116 (S31). Moreover, the volume data rendering unit 124 reads the ray tracing distance from the depth buffer 134 (S32). Subsequently, the volume data rendering unit 124 starts execution of the ray marching (S33).

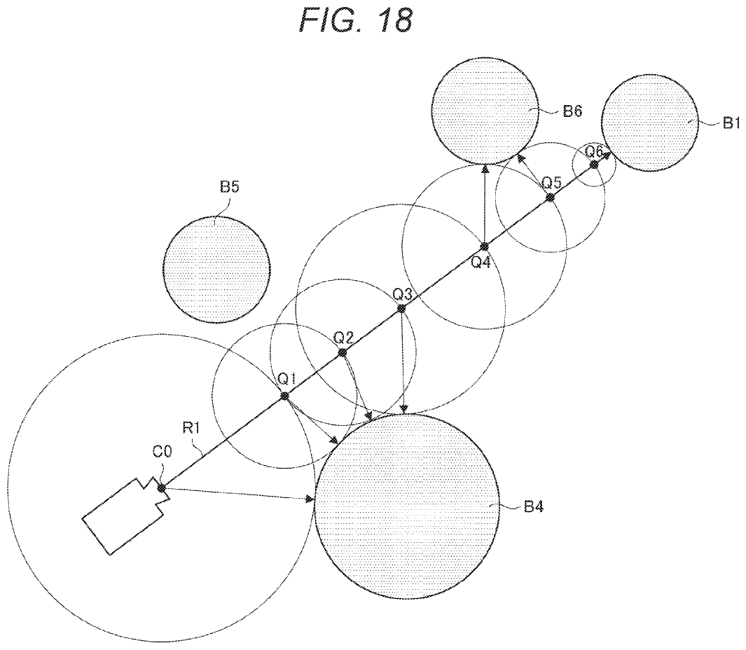

Here, the outline of the ray marching method will be described with reference to FIG. 18.

FIG. 18 is a diagram for describing the outline of the ray marching method. Referring to FIG. 18, the viewpoint C0 is present in the CG space. Furthermore, a direction R1 of the ray splashed from the viewpoint C0 is illustrated. Furthermore, objects B1 and B4 to B6 are present in the CG space.

In the ray marching method, the viewpoint C0 is set as a start position, and an object having the shortest distance from the current position is detected. Then, the ray advances by the shortest distance, and in a case where an object having the shortest distance equal to or less than a threshold is not detected, the ray similarly advances.

In a case where an object having the shortest distance equal to or less than the threshold is detected, the object is set as the rendering target. On the other hand, in a case where the shortest distance is not equal to or less than the threshold and the number of times of causing the ray to advance exceeds a predetermined number of times, it is determined that there is nothing in the direction of the ray R1, and the ray marching is ended.

In the example illustrated in FIG. 18, the ray advances in the order of points Q1 to Q6. Then, at a stage where the ray has advanced to the point Q6, the distance between the object B1 and the current position becomes the shortest, the shortest distance becomes equal to or less than the threshold, and thus, the object B1 is determined as the rendering target.

Returning to FIG. 16, the description will be continued. The volume data rendering unit 124 selects a pixel (S34), and calculates a ray position and a ray direction with a camera position (viewpoint position) as a reference (S35). The ray position and the ray direction calculated here are the ray position and the ray direction in a camera coordinate system. The volume data rendering unit 124 acquires the ray tracing distance corresponding to the pixel being selected from the depth buffer 134 (S36). The volume data rendering unit 124 converts the calculated ray position and ray direction in the camera coordinate system into the ray position and ray direction in a world coordinate system (S37).

The volume data rendering unit 124 causes the ray to advance in the depth direction with the camera position as a reference (S41), and shifts the operation to S47 in a case where the length of the ray is equal to or greater than the ray tracing distance (“NO” in S42). On the other hand, in a case where the length of the ray is smaller than the ray tracing distance (“YES” in S42), the volume data rendering unit 124 determines whether or not the volume data is present at the position of the ray (S43).

In a case where the volume data is not present at the position of the ray (“NO” in S43), the volume data rendering unit 124 shifts the operation to S41. On the other hand, in a case where the volume data is present at the position of the ray (“YES” in S43), the volume data rendering unit 124 extracts the volume data present at the position of the ray (S44).

Then, the volume data rendering unit 124 adds the RGBα value of the extracted volume data to the RGBα value corresponding to the pixel being selected (S45), and in this case, each of the RGB values is combined by a blending.

In a case where the total value of the a values of the volume data extracted in the pixel being selected is smaller than 1 (predetermined value) (“YES” in S46), the volume data rendering unit 124 maintains the pixel being selected, and shifts the operation to S41. On the other hand, in a case where the total value is equal to or greater than 1 (“NO” in S46), the volume data rendering unit 124 writes the RGBα value corresponding to the pixel being selected in a position corresponding to the pixel being selected in the second color buffer 136 (S47).

While there is an unprocessed pixel (“YES” in S48), the volume data rendering unit 124 shifts the operation to S34. On the other hand, in a case where there is no unprocessed pixel (“YES” in S48), the volume data rendering unit 124 ends the rendering of the volume data (S30).

The operation example of the information processing apparatus 10 according to the embodiment of the present disclosure has been described above.

### 2. Various Modification Examples

Next, various modification examples of the information processing apparatus 10 according to the embodiment of the present disclosure will be described.

### First Modification Example

The case where the rendering of the volume data is performed regardless of the viewpoint of the user has been described above. However, in a case where the user is far from a viewing target, the visibility of the rendering result of the volume data decreases, and thus, it can be assumed that the effect contributed by the rendering of the volume data is not so large.

Therefore, the volume data rendering unit 124 may control whether or not to render the volume data on the basis of the distance between the user and the viewing target. As a result, since the rendering of the volume data is performed only in a case where the effect contributed by the rendering of the volume data is large, the processing load due to the rendering can be reduced. Note that the position of the user may be the position of the viewpoint of the user (for example, the viewpoint C0 described above), and the viewing target may be the polygon data.

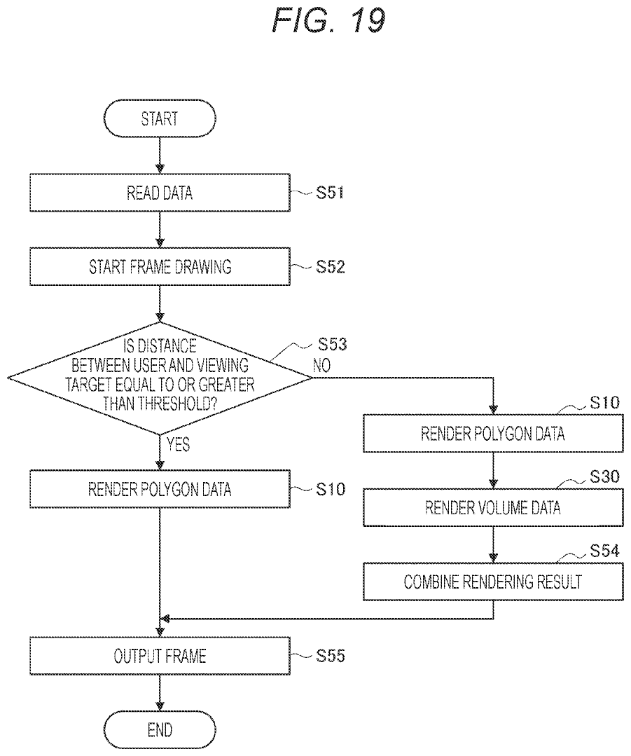

FIG. 19 is a flowchart illustrating an operation example of the information processing apparatus 10 according to the first modification example. As illustrated in FIG. 19, the polygon data rendering unit 122 and the volume data rendering unit 124 read various kinds of data (S51).

More specifically, the polygon data rendering unit 122 reads the polygon data from the polygon data storage unit 112. Moreover, the polygon data rendering unit 122 acquires the label from the volume superimposition label data storage unit 114. Furthermore, the volume data rendering unit 124 acquires the volume data from the volume data storage unit 116.

The polygon data rendering unit 122 determines the relationship between the distance between the user and the viewing target and the threshold (S53). In a case where the distance between the user and the viewing target is equal to or greater than the threshold (“YES” in S53), the polygon data rendering unit 122 renders the polygon data on the basis of the polygon data and the label (S10). In such a case, the volume data rendering unit 124 does not search the volume data, and does not render the volume data.

On the other hand, in a case where the distance between the user and the viewing target is smaller than the threshold (“NO” in S53), the polygon data rendering unit 122 renders the polygon data on the basis of the polygon data and the label (S10), and writes the ray tracing distance in the depth buffer 134. In a case where the distance between the user and the viewing target is smaller than the threshold, the volume data rendering unit 124 searches the volume data on the basis of the ray tracing distance written in the depth buffer 134 and the volume data, and renders the volume data (S30).

The buffer combining unit 126 combines the rendering result of the polygon data and the rendering result of the volume data (S54). The image output unit 140 outputs the combining result by the buffer combining unit 126 as a frame (S55).

### Second Modification Example

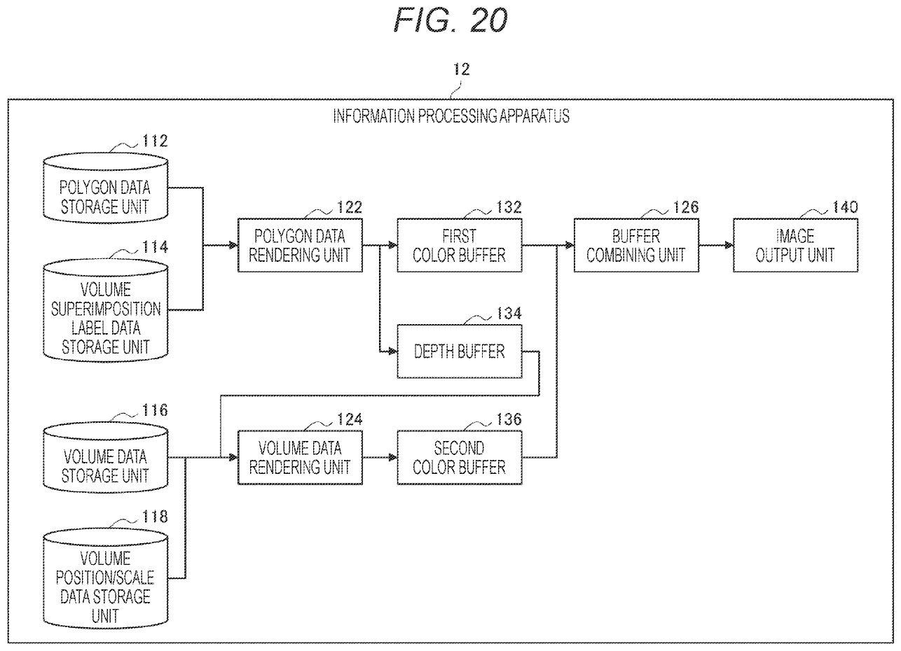

FIG. 20 is a diagram for describing a configuration example of an information processing apparatus 12 according to the second modification example. The information processing apparatus 12 according to the second modification example is also realized by a computer, and includes a control unit (not illustrated) and a storage unit (not illustrated). However, as illustrated in FIG. 20, in the second modification example, the storage unit (not illustrated) further includes a volume position/scale data storage unit 118.

### (Volume Position/Scale Data Storage Unit 118)

The volume position/scale data storage unit 118 stores data indicating the origin position of the polygon data and data indicating the scale of the polygon data. Moreover, the volume position/scale data storage unit 118 stores data indicating the origin position of the volume data and data indicating the scale of the volume data.

The volume data rendering unit 124 acquires data indicating the origin position of the polygon data and data indicating the scale of the polygon data from the volume position/scale data storage unit 118, and acquires data indicating the origin position of the volume data and data indicating the scale of the volume data.

The volume data rendering unit 124 may match the origin positions between the polygon data and the volume data on the basis of the data indicating the origin position of the polygon data and the data indicating the origin position of the volume data. Moreover, the volume data rendering unit 124 may match the scales between the polygon data and the volume data on the basis of the data indicating the scale of the polygon data and the data indicating the scale of the volume data.

Various modification examples of the information processing apparatus 10 according to the embodiment of the present disclosure have been described above.

### 3. Hardware Configuration Example

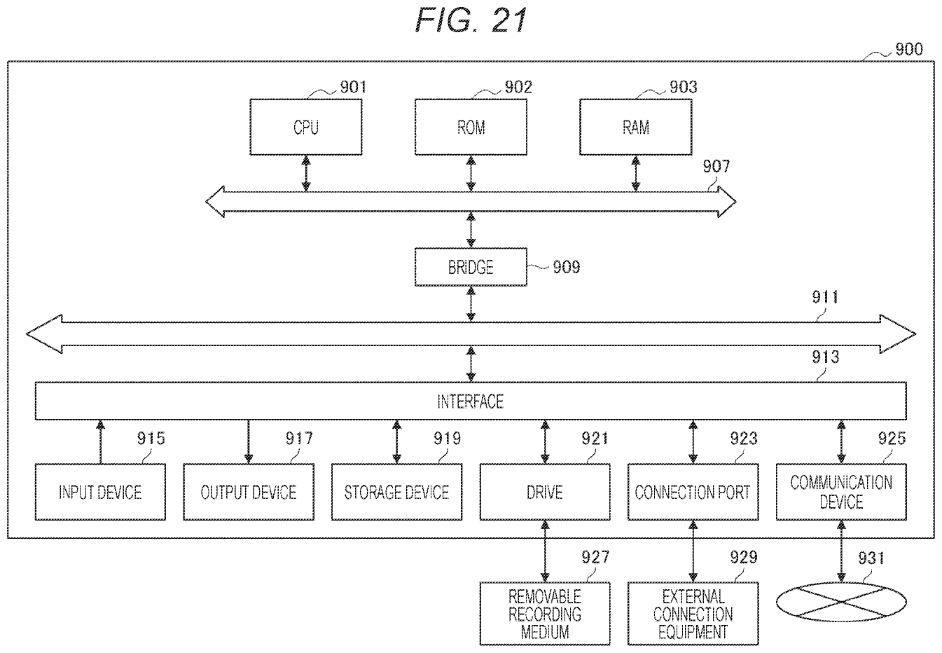

Next, a hardware configuration example of an information processing apparatus 900 as an example of the information processing apparatus 10 according to the embodiment of the present disclosure will be described with reference to FIG. 21. FIG. 21 is a block diagram illustrating a hardware configuration example of the information processing apparatus 900. Note that the information processing apparatus 10 does not necessarily have to have the whole hardware configuration illustrated in FIG. 21, and a part of the hardware configuration illustrated in FIG. 21 may not be present within the information processing apparatus 10.

As illustrated in FIG. 21, the information processing apparatus 900 includes a central processing unit (CPU) 901, a read-only memory (ROM) 903, and a random-access memory (RAM) 905. Furthermore, the information processing apparatus 900 may include a host bus 907, a bridge 909, an external bus 911, an interface 913, an input device 915, an output device 917, a storage device 919, a drive 921, a connection port 923, and a communication device 925. The information processing apparatus 900 may have a processing circuit called a digital signal processor (DSP) or an application specific integrated circuit (ASIC) instead of or in combination with the CPU 901.

The CPU 901 functions as an arithmetic processor and a control device, and controls overall operation in the information processing apparatus 900 or a part thereof, in accordance with various programs recorded in the ROM 903, the RAM 905, the storage device 919, or a removable recording medium 927. The ROM 903 stores programs, calculation parameters, and the like used by the CPU 901. The RAM 905 temporarily stores a program used in execution by the CPU 901, parameters that change as appropriate during the execution, and the like. The CPU 901, the ROM 903, and the RAM 905 are mutually connected by the host bus 907 including an internal bus such as a CPU bus. Moreover, the host bus 907 is connected to the external bus 911 such as a peripheral component interconnect/interface (PCI) bus via the bridge 909.

The input device 915 is, for example, a device operated by the user, such as a button. The input device 915 may include a mouse, a keyboard, a touch panel, a switch, a lever, or the like. Furthermore, the input device 915 may also include a microphone that detects voice of the user. The input device 915 may be, for example, a remote control device using infrared rays or other radio waves, or may be external connection equipment 929 such as a mobile phone adapted to the operation of the information processing apparatus 900. The input device 915 includes an input control circuit that generates and outputs an input signal to the CPU 901 on the basis of the information input by the user. By operating the input device 915, the user inputs various kinds of data or gives an instruction to perform a processing operation, to the information processing apparatus 900. Furthermore, an imaging device 933 as described later can function as the input device by capturing an image of motion of the user's hand, the user's finger, or the like. In this case, a pointing position may be determined in accordance with the motion of the hand and the direction of the finger.

The output device 917 includes a device that can visually or audibly notify the user of acquired information. The output device 917 may be, for example, a display device such as a liquid crystal display (LCD) or an organic electro-luminescence (EL) display, a sound output device such as a speaker or a headphone, or the like. Furthermore, the output device 917 may include a plasma display panel (PDP), a projector, a hologram, a printer device, or the like. The output device 917 outputs a result of processing performed by the information processing apparatus 900 as a video such a text or an image, or outputs the result as a sound such as voice or audio. Furthermore, the output device 917 may include a light or the like in order to brighten the surroundings.

The storage device 919 is a data storage device configured as an example of a storage unit of the information processing apparatus 900. The storage device 919 includes, for example, a magnetic storage device such as a hard disk drive (HDD), a semiconductor storage device, an optical storage device, a magneto-optical storage device, or the like. The storage device 919 stores programs executed by the CPU 901 and various kinds of data, various kinds of data acquired from the outside, and the like.

The drive 921 is a reader/writer for the removable recording medium 927, such as a magnetic disk, an optical disc, a magneto-optical disk, or a semiconductor memory, and is built in or externally attached to the information processing apparatus 900. The drive 921 reads information recorded in the mounted removable recording medium 927, and outputs the read information to the RAM 905. Furthermore, the drive 921 writes records in the mounted removable recording medium 927.

The connection port 923 is a port for directly connecting equipment to the information processing apparatus 900. The connection port 923 may be, for example, a universal serial bus (USB) port, an IEEE1394 port, a small computer system interface (SCSI) port, or the like. Furthermore, the connection port 923 may be an RS-232C port, an optical audio terminal, a high-definition multimedia interface (HDMI (registered trademark)) port, or the like. By connecting the external connection equipment 929 to the connection port 923, various kinds of data can be exchanged between the information processing apparatus 900 and the external connection equipment 929.

The communication device 925 is, for example, a communication interface including a communication device or the like for connecting to a network 931. The communication device 925 may be, for example, a communication card for a wired or wireless local area network (LAN), Bluetooth (registered trademark), wireless USB (WUSB), or the like. Furthermore, the communication device 925 may be a router for optical communication, a router for asymmetric digital subscriber line (ADSL), a modem for various types of communication, or the like. For example, the communication device 925 transmits and receives signals and the like to and from the Internet and other communication equipment, by using a predetermined protocol such as TCP/IP. Furthermore, the network 931 connected to the communication device 925 is a network connected in a wired or wireless manner, and is, for example, the Internet, a home LAN, infrared communication, radio wave communication, satellite communication, or the like.

### 4. Summary

According to the embodiment of the present disclosure, there is provided an information processing apparatus including a search unit that searches volume data on the basis of a label indicating whether to search the volume data for inner-side data present at a position included in polygon data, and that obtains a search result; and a rendering unit that performs rendering based on the polygon data and the volume data on the basis of the search result.

According to such a configuration, rendering utilizing the respective features of the polygon data and the volume data is performed, and thus rendering with reduced discomfort given to the user is expected to be possible.

While the preferred embodiment of the present disclosure has been described above in detail with reference to the drawings, the technical scope of the present disclosure is not limited thereto. It is obvious that a person having ordinary knowledge in the technical field of the present disclosure could arrive at various changes or modifications within the scope of the technical idea set forth in the claims, and it is understood that such changes or modifications naturally belong to the technical scope of the present disclosure.

Furthermore, the effects described in the present specification are merely exemplary or illustrative, and are not restrictive. That is, the technique according to the present disclosure may provide other effects described above that are apparent to those skilled in the art from the description of the present specification, in addition to or instead of the effects described above.

Note that the following configurations also fall within the technical scope of the present disclosure.

(1)

An information processing apparatus including:
a search unit that searches volume data on the basis of a label indicating whether to search the volume data for inner-side data present at a position included in polygon data, and that obtains a search result; and
a rendering unit that performs rendering based on the polygon data and the volume data on the basis of the search result.

(2)

The information processing apparatus according to (1) described above, in which
the search unit does not search for the inner-side data on the basis of the label indicating that the inner-side data is not to be searched for, and searches for the inner-side data on the basis of the label indicating that the inner-side data is to be searched for.

(3)

The information processing apparatus according to (1) or (2) described above, in which
the search unit searches the volume data in a depth direction with a predetermined viewpoint as a reference, and searches the volume data for near-side data positioned in front of the polygon data with the viewpoint as a reference, regardless of the label.

(4)

The information processing apparatus according to (3) described above, in which
the search unit writes a distance according to the label in a depth buffer, causes a point of interest to advance stepwise in the depth direction with the viewpoint as a reference, and extracts volume data present in the point of interest in a case where a distance between the viewpoint and the point of interest is smaller than the distance written in the depth buffer and the volume data is present at the point of interest, and
the rendering unit performs rendering based on the extracted volume data and the polygon data.

(5)

The information processing apparatus according to (4) described above, in which
the search unit writes a predetermined distance in the depth buffer on the basis of the label indicating that the inner-side data is to be searched for.

(6)

The information processing apparatus according to (5) described above, in which
the predetermined distance is a distance equal to or greater than a maximum value of a distance between the viewpoint and the volume data.

(7)

The information processing apparatus according to any one of (4) to (6) described above, in which
the search unit writes a distance between the viewpoint and the polygon data in the depth buffer on the basis of the label indicating that the inner-side data is not to be searched for.

(8)

The information processing apparatus according to any one of (4) to (6), in which
the search unit causes the point of interest to advance in a case where a total value of transmittance of the extracted volume data is smaller than a predetermined value.

(9)

The information processing apparatus according to any one of (4) to (8), in which
the rendering unit acquires a volume data combining result obtained by combining the extracted volume data on the basis of transmittance of the extracted volume data.

(10)

The information processing apparatus according to (9) described above, in which
the rendering unit outputs the volume data combining result in a case where the label indicates that the inner-side data is to be searched for.

(11)

The information processing apparatus according to (9) or (10) described above, in which
the rendering unit outputs a combining result of the volume data combining result and a rendering result of the polygon data in a case where the label indicates that the inner-side data is not to be searched for.

(12)

The information processing apparatus according to (11) described above, in which
the rendering unit combines the polygon data and the volume data combining result on the basis of a total value of transmittance of the extracted volume data and transmittance of the polygon data.

(13)

The information processing apparatus according to any one of (1) to (12) described above, in which
the rendering unit controls whether or not to perform rendering of the volume data on the basis of a distance between a viewpoint of a user and the polygon data.

(14)

The information processing apparatus according to (13) described above, in which
the rendering unit performs rendering of the polygon data without performing rendering of the volume data in a case where the distance between the viewpoint of the user and the polygon data is greater than a threshold.

(15)

The information processing apparatus according to (13) described above, in which
the search unit does not search the volume data in a case where the distance between the viewpoint of the user and the polygon data is greater than a threshold.

(16)

The information processing apparatus according to (13) described above, in which
the rendering unit performs rendering based on the polygon data and the volume data on the basis of the search result in a case where the distance between the viewpoint of the user and the polygon data is smaller than a threshold.

(17)

The information processing apparatus according to (13) described above, in which
the search unit searches the volume data on the basis of the label in a case where the distance between the viewpoint of the user and the polygon data is smaller than a threshold.

(18)

The information processing apparatus according to any one of (1) to (17) described above, in which
the rendering unit matches at least one of origin positions or scales between the polygon data and the volume data.

(19)

An information processing method including:
searching volume data on the basis of a label indicating whether to search the volume data for inner-side data present at a position included in polygon data, and obtaining a search result; and
performing rendering based on the polygon data and the volume data on the basis of the search result via a processor.

(20)

A program causing a computer to function as an information processing apparatus including:
a search unit that searches volume data on the basis of a label indicating whether to search the volume data for inner-side data present at a position included in polygon data, and that obtains a search result; and
a rendering unit that performs rendering based on the polygon data and the volume data on the basis of the search result.

### REFERENCE SIGNS LIST

10, 12 Information processing apparatus
112 Polygon data storage unit
114 Volume superimposition label data storage unit
116 Volume data storage unit
118 Volume position/scale data storage unit
122 Polygon data rendering unit
124 Volume data rendering unit
126 Buffer combining unit
132 First color buffer
134 Depth buffer
136 Second color buffer
140 Image output unit
30 Volume data
31 Near-side data
32 Inner-side data

1. An information processing apparatus comprising:
a search unit that searches volume data on a basis of a label indicating whether to search the volume data for inner-side data present at a position included in polygon data, and that obtains a search result; and
a rendering unit that performs rendering based on the polygon data and the volume data on a basis of the search result.

2. The information processing apparatus according to claim 1, wherein
the search unit does not search for the inner-side data on a basis of the label indicating that the inner-side data is not to be searched for, and searches for the inner-side data on a basis of the label indicating that the inner-side data is to be searched for.

3. The information processing apparatus according to claim 1, wherein
the search unit searches the volume data in a depth direction with a predetermined viewpoint as a reference, and searches the volume data for near-side data positioned in front of the polygon data with the viewpoint as a reference, regardless of the label.

4. The information processing apparatus according to claim 3, wherein
the search unit writes a distance according to the label in a depth buffer, causes a point of interest to advance stepwise in the depth direction with the viewpoint as a reference, and extracts volume data present in the point of interest in a case where a distance between the viewpoint and the point of interest is smaller than the distance written in the depth buffer and the volume data is present at the point of interest, and
the rendering unit performs rendering based on the extracted volume data and the polygon data.

5. The information processing apparatus according to claim 4, wherein
the search unit writes a predetermined distance in the depth buffer on a basis of the label indicating that the inner-side data is to be searched for.

6. The information processing apparatus according to claim 5, wherein
the predetermined distance is a distance equal to or greater than a maximum value of a distance between the viewpoint and the volume data.

7. The information processing apparatus according to claim 4, wherein
the search unit writes a distance between the viewpoint and the polygon data in the depth buffer on a basis of the label indicating that the inner-side data is not to be searched for.

8. The information processing apparatus according to claim 4, wherein
the search unit causes the point of interest to advance in a case where a total value of transmittance of the extracted volume data is smaller than a predetermined value.

9. The information processing apparatus according to claim 4, wherein
the rendering unit acquires a volume data combining result obtained by combining the extracted volume data on a basis of transmittance of the extracted volume data.

10. The information processing apparatus according to claim 9, wherein
the rendering unit outputs the volume data combining result in a case where the label indicates that the inner-side data is to be searched for.

11. The information processing apparatus according to claim 9, wherein
the rendering unit outputs a combining result of the volume data combining result and a rendering result of the polygon data in a case where the label indicates that the inner-side data is not to be searched for.

12. The information processing apparatus according to claim 11, wherein
the rendering unit combines the polygon data and the volume data combining result on a basis of a total value of transmittance of the extracted volume data and transmittance of the polygon data.

13. The information processing apparatus according to claim 1, wherein
the rendering unit controls whether or not to perform rendering of the volume data on a basis of a distance between a viewpoint of a user and the polygon data.

14. The information processing apparatus according to claim 13, wherein
the rendering unit performs rendering of the polygon data without performing rendering of the volume data in a case where the distance between the viewpoint of the user and the polygon data is greater than a threshold.

15. The information processing apparatus according to claim 13, wherein
the search unit does not search the volume data in a case where the distance between the viewpoint of the user and the polygon data is greater than a threshold.

16. The information processing apparatus according to claim 13, wherein
the rendering unit performs rendering based on the polygon data and the volume data on a basis of the search result in a case where the distance between the viewpoint of the user and the polygon data is smaller than a threshold.

17. The information processing apparatus according to claim 13, wherein
the search unit searches the volume data on a basis of the label in a case where the distance between the viewpoint of the user and the polygon data is smaller than a threshold.

18. The information processing apparatus according to claim 1, wherein
the rendering unit matches at least one of origin positions or scales between the polygon data and the volume data.

19. An information processing method comprising:
searching volume data on a basis of a label indicating whether to search the volume data for inner-side data present at a position included in polygon data, and obtaining a search result; and
performing rendering based on the polygon data and the volume data on a basis of the search result via a processor.

20. A program causing a computer to function as an information processing apparatus including:
a search unit that searches volume data on a basis of a label indicating whether to search the volume data for inner-side data present at a position included in polygon data, and that obtains a search result; and
a rendering unit that performs rendering based on the polygon data and the volume data on a basis of the search result.
